(19) United States
(12) Patent Application Publication
(10) Pub. No.: US 2011/0249439 A1
(43) Pub. Date: Oct. 13, 2011

(54) ILLUMINATION DEVICE

(76) Inventors: Jen-Feng Chen, Taichung City (TW); Rou-Ching Yang, Taipei City (TW)

(21) Appl. No.: 13/082,402

(22) Filed: Apr. 8, 2011

(30) Foreign Application Priority Data
Apr. 9, 2010 (TW) 099111065

(51) Int. Cl. F21V 19/02

(52) U.S. Cl. 362/249.1

(57) ABSTRACT

An illumination device includes a first illumination unit, a second illumination unit and a driving mechanism. The first illumination unit has a first illumination direction and the second illumination unit has a second illumination direction. The first and second illumination units are pivotally connected to the driving mechanism. The driving mechanism is capable of driving the first and second illumination units to rotate with respect to the driving mechanism. The illumination device can be operated in a first state and a second state. When the illumination device is operated in the first state, the first illumination direction does not intersect the second illumination direction. When the illumination device is operated in the second state, the first illumination direction intersects the second illumination direction.

### BACKGROUND OF THE INVENTION

1. Field of the Invention

The invention relates to an illumination device and, more particularly, to an illumination device capable of driving at least two illumination units to rotate simultaneously, so as to change light field.

2. Description of the Prior Art

Illumination devices are the necessaries of life. Many changes have taken place in the way of life due to the illumination devices. At present, there are various illumination devices, such as fluorescent lights, desk lights, suspension lights, street lights, and so on, installed in a common household or public place. An illumination device not only can be used to illuminate a dark place but also can be used to emit specific illumination light by changing light source color, light emitting frequency, and so on, so as to enhance vision effect. Furthermore, a plurality of light sources may be installed in an illumination device so as to increase illumination area. In general, each of the light sources of the illumination device has one single illumination direction. If a user wants to change light field of the illumination device so as to concentrate or diffuse light, he or she has to adjust all the light sources individually. It is very inconvenient for the user.

### SUMMARY OF THE INVENTION

An objective of the invention is to provide an illumination device utilizing a driving mechanism to drive at least two illumination units simultaneously, so as to change light field. Accordingly, the aforesaid problem can be solved.

According to one embodiment of the invention, an illumination device comprises a first illumination unit, a second illumination unit and a driving mechanism. The first illumination unit has a first illumination direction and the second illumination unit has a second illumination direction. The first and second illumination units are pivotally connected to the driving mechanism. The driving mechanism is capable of driving the first and second illumination units to rotate with respect to the driving mechanism. In this embodiment, the illumination device is capable of being operated in a first state and a second state. When the illumination device is operated in the first state, the first illumination direction does not intersect the second illumination direction. When the illumination device is operated in the second state, the first illumination direction intersects the second illumination direction. In other words, a light field generated by the illumination in the first state is different from a light field generated by the illumination in the second state.

As mentioned in the above, the driving mechanism of the illumination device of the invention is capable of driving the first and second illumination units to rotate, such that the first illumination direction intersects or does not intersect the second illumination direction. Accordingly, a user may easily change light field generated by the illumination device based on different illumination requirements.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating an illumination device according to a first embodiment of the invention.

FIG. 2 is a front view illustrating the illumination device shown in FIG. 1.

FIG. 3 is an exploded view illustrating the illumination device shown in FIG. 1.

FIG. 4 is an exploded view illustrating the illumination device shown in FIG. 1 from another view angle.

FIG. 5 is a schematic diagram illustrating the illumination device in FIG. 2 operated in a second state.

FIG. 6 is a sectional view illustrating the illumination device along line X-X in FIG. 5.

FIG. 7 is a schematic diagram illustrating the illumination device in FIG. 2 operated in a third state.

FIG. 8 is a sectional view illustrating the illumination device along line Y-Y in FIG. 7.

FIG. 9 is a perspective view illustrating a sliding member according to a second embodiment of the invention, wherein FIG. 9(A) is a right side perspective view and FIG. 9(B) is a left side perspective view.

FIG. 10 is a front view illustrating an illumination device according to the second embodiment of the invention.

FIG. 11 is a front view illustrating an illumination device according to a third embodiment of the invention.

FIG. 12 is a perspective view illustrating an illumination device according to a fourth embodiment of the invention.

FIG. 13 is a front view illustrating the illumination device shown in FIG. 12.

FIG. 14 is an exploded view illustrating the illumination device shown in FIG. 12.

FIG. 15 is an exploded view illustrating the illumination device shown in FIG. 12 from another view angle.

FIG. 16 is a front view illustrating the worm shaft meshing with the first and second worm gears in FIG. 14.

FIG. 17 is a schematic diagram illustrating the illumination device in FIG. 13 operated in a second state.

FIG. 18 is a front view illustrating the worm shaft meshing with the first and second worm gears when the illumination device is operated in the second state.

FIG. 19 is a schematic diagram illustrating the illumination device in FIG. 13 operated in a third state.

FIG. 20 is a front view illustrating the worm shaft meshing with the first and second worm gears when the illumination device is operated in the third state.

FIG. 21 is an inner front view illustrating an illumination device according to a fifth embodiment of the invention.

FIG. 22 is a front view illustrating an illumination device according to a sixth embodiment of the invention.

FIG. 23 is a diagram illustrating the illumination distribution of the illumination operated in the first state.

FIG. 24 is a diagram illustrating the illumination distribution of the illumination operated in the second state.

FIG. 25 is a diagram illustrating the illumination distribution of the illumination operated in the third state.

### DETAILED DESCRIPTION

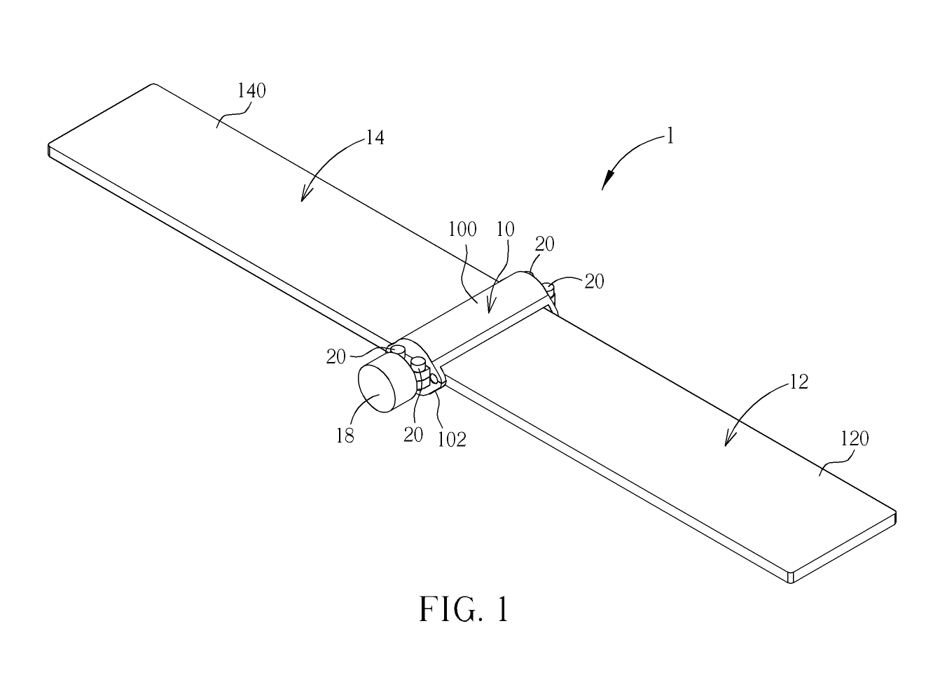

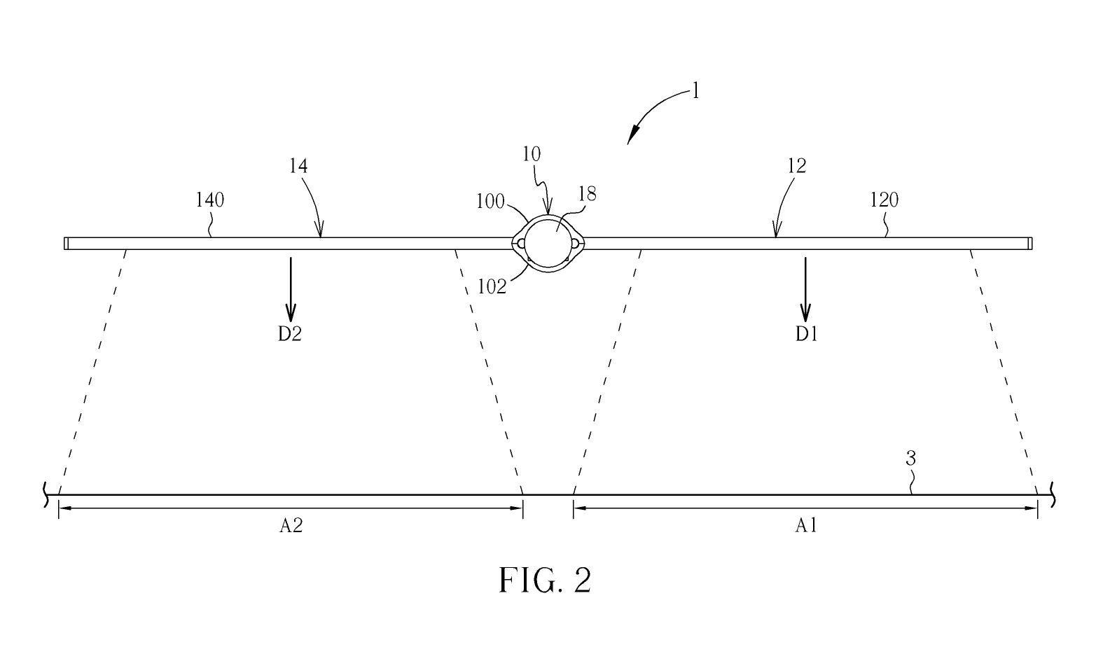

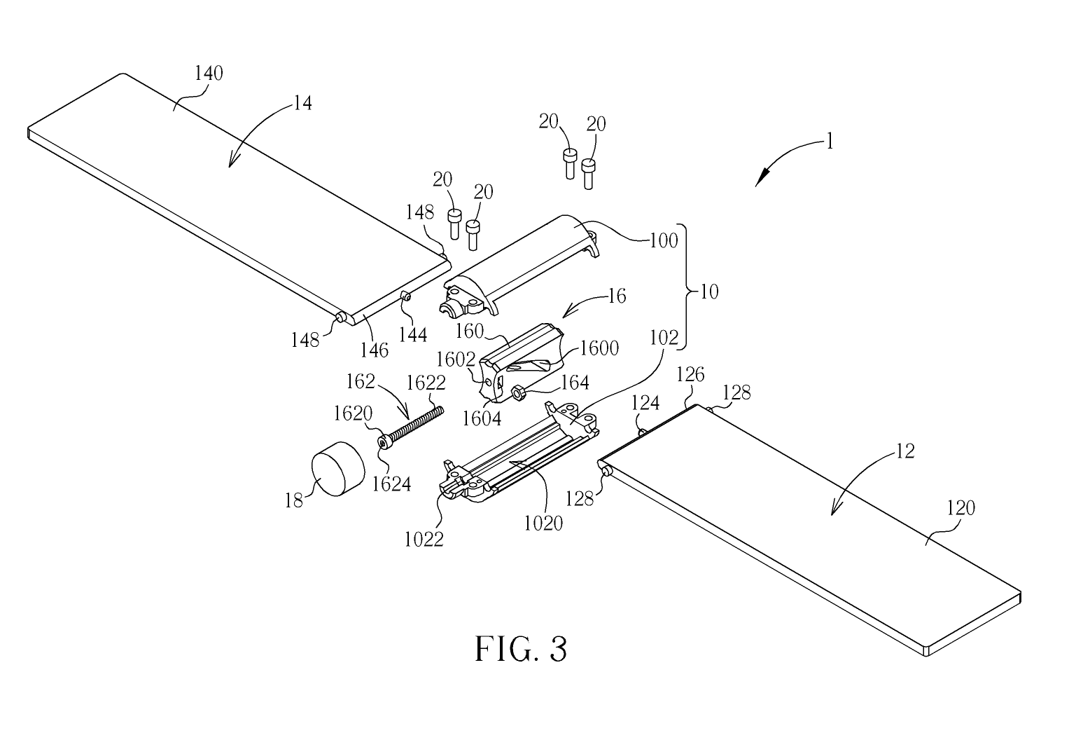

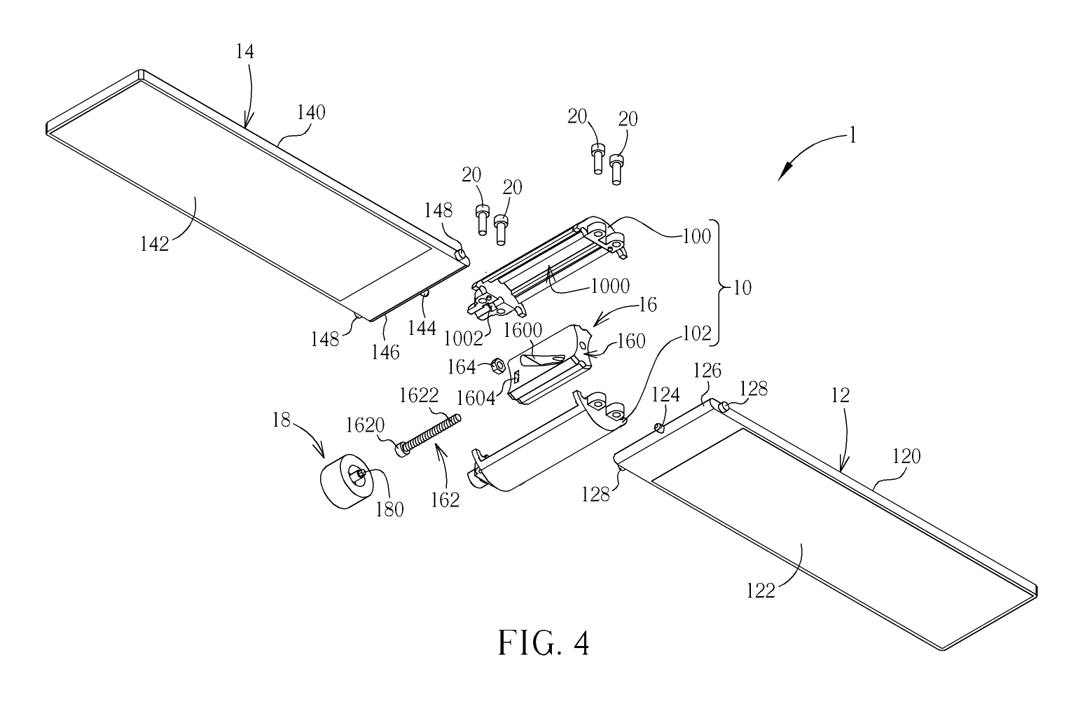

Referring to FIGS. 1 to 4, FIG. 1 is a perspective view illustrating an illumination device 1 according to a first embodiment of the invention, FIG. 2 is a front view illustrating the illumination device 1 shown in FIG. 1, FIG. 3 is an exploded view illustrating the illumination device 1 shown in FIG. 1, and FIG. 4 is an exploded view illustrating the illumination device 1 shown in FIG. 1 from another view angle. The illumination device 1 of the invention may be, but not limited to, fluorescent light, desk light, suspension light, street light, and so on. The illumination device 1 comprises a casing 10, a first illumination unit 12, a second illumination unit 14, a driving mechanism 16 and an actuating unit 18.

In this embodiment, the first illumination unit 12 may comprise a first rectangular flat structure 120 and a first light source module 122, a first protruding portion 124 protrudes from a first connecting edge 126 of the first rectangular flat structure 120, and the first light source module 122 is disposed in the first rectangular flat structure 120. The second illumination unit 14 may comprise a second rectangular flat structure 140 and a second light source module 142, a second protruding portion 144 protrudes from a second connecting edge 146 of the second rectangular flat structure 140, and the second light source module 142 is disposed in the second rectangular flat structure 140. It should be noted that the first and second light source modules 122, 142 can be also disposed in other structures including circular structure, oval-shaped structure, polygonal structure, and so on, so as to form the first and second illumination units 12, 14. That is to say, the invention is not limited to the aforesaid rectangular flat structure and can be designed based on practical applications. Furthermore, in practical applications, the first and second light source modules 122, 142 may be, but not limited to, light emitting diode modules.

The driving mechanism 16 is disposed in the casing 10. The casing 10 comprises an upper casing 100 and a lower casing 102. The upper and lower casings 100, 102 may be fixed together by a plurality of fixing members 20, such as screws. As shown in FIGS. 3 and 4, the upper casing 100 has a sliding groove 1000 and the lower casing 102 has a sliding groove 1020. In this embodiment, the driving mechanism 16 may comprise a sliding member 160, a screw rod 162 and a screw nut 164. The sliding member 160 is slidably disposed in the first and second sliding grooves 1000, 1020. The sliding member 160 has an oblique sliding groove 1600 and an opening 1602.

The first illumination unit 12 can be pivotally connected to the casing 10 by two pivoting portions 128 formed on opposite sides of the first connecting edge 126, and the first protruding portion 124 is disposed in the oblique sliding groove 1600 from one side of the oblique sliding groove 1600, such that the first connecting edge 126 is coupled to the driving mechanism 16. Similarly, the second illumination unit 14 can be pivotally connected to the casing 10 by two pivoting portions 148 formed on opposite sides of the second connecting edge 146, and the second protruding portion 144 is disposed in the oblique sliding groove 1600 from the other side of the oblique sliding groove 1600, such that the second connecting edge 146 is coupled to the driving mechanism 16.

The screw nut 164 has a screw structure therein. The screw nut 164 can be inserted into a hole 1604 formed on one side of the sliding member 160 so as to be disposed in the opening 1602. One end 1620 of the screw rod 162 is engaged in a recess 1002 (as shown in FIG. 4) of the casing 100 and a recess 1022 (as shown in FIG. 3) of the lower casing 102, such that the screw rod 162 is rotatably and immovably disposed in the casing 10. The other end 1622 of the screw rod 162 is disposed in the opening 1602 of the sliding member 160, such that the outer thread of the screw rod 162 meshes with the screw structure within the screw nut 164. It should be noted that the invention can also form the screw structure in the opening of the sliding member 160 so as to leave out the screw nut 164. Moreover, the actuating unit 18 is disposed on the casing 10 and an engaging portion 180 (as shown in FIG. 4) of the actuating unit 18 is connected to an engaging hole 1624 (as shown in FIG. 3) of the screw rod 162.

When the actuating unit 18 rotates, the actuating unit 18 can actuate the screw rod 162 to rotate. Since the screw rod 162 can only rotate with respect to the casing 10 and cannot move with respect to the casing 10, the screw structure, which meshes with the screw rod 162, will drive the sliding member 160 to slide with respect to the casing 10. When the sliding member 160 slides with respect to the casing 10, the first and second protruding portions 124, 144 will move to different positions with respect to the oblique sliding groove 1600 respectively. Consequently, the first and second illumination units 12, 14 will rotate with respect to the driving mechanism 16.

As show in FIG. 2, the illumination device 1 is disposed over a plane 3. The first illumination unit 12 has a first illumination direction D1 and the second illumination unit 14 has a second illumination direction D2. When the illumination device 1 is operated in the first state shown in FIG. 2, the first and second illumination directions D1, D2 are perpendicular to the plane 3, such that the first illumination direction D1 does not intersect the second illumination direction D2. At this time, the first illumination unit 12 generates a first illumination area A1 on the plane 3, the second illumination unit 14 generates a second illumination area A2 on the plane 3, and the first illumination area A1 is staggered with the second illumination area A2.

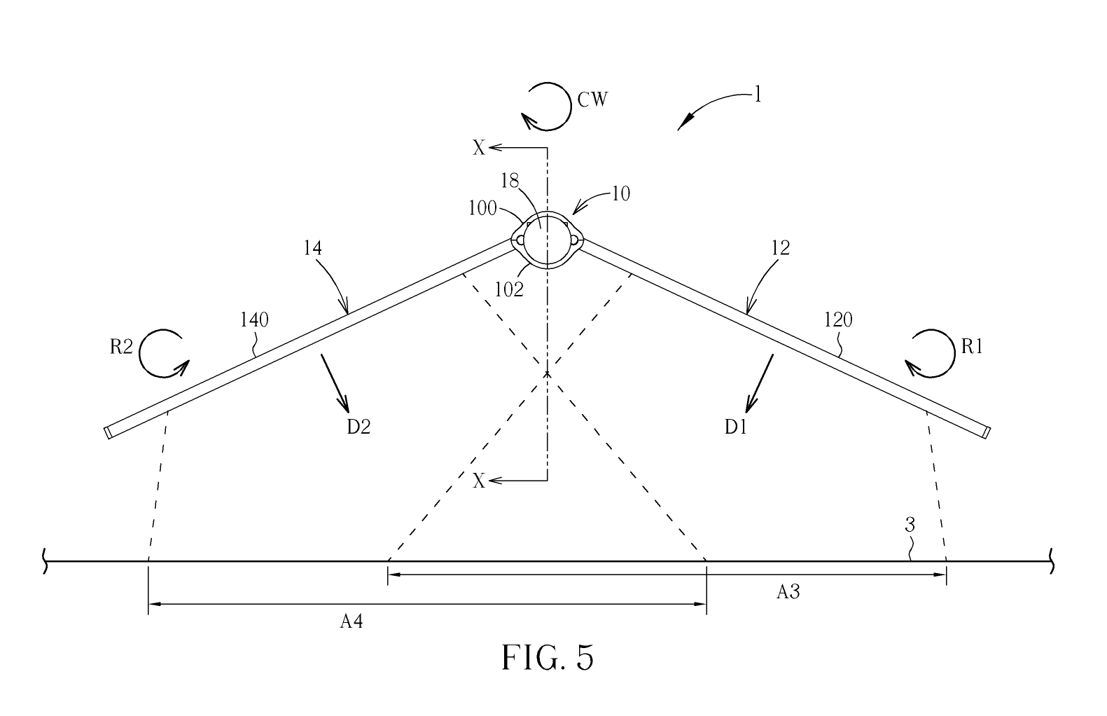

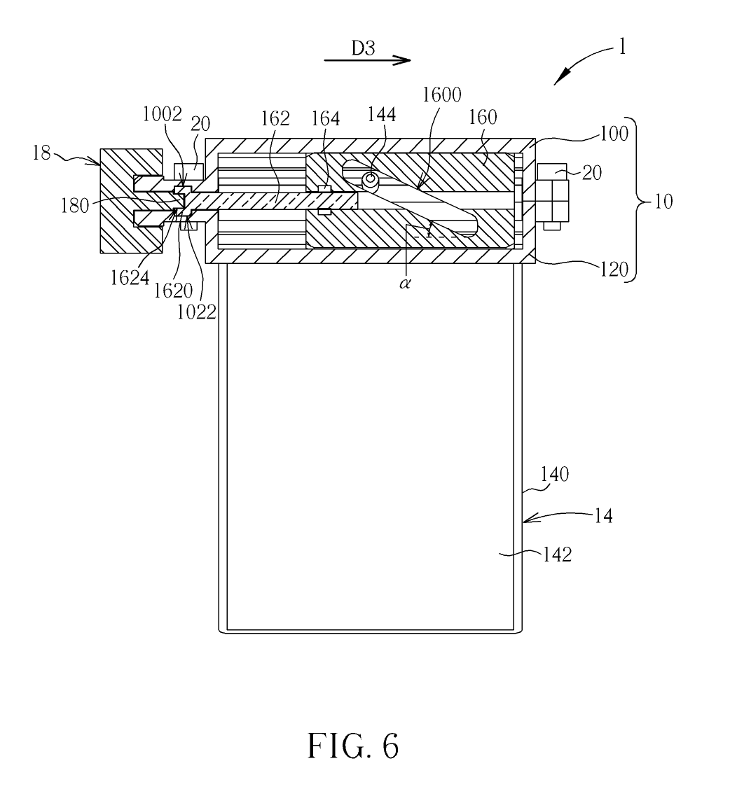

Referring to FIGS. 5 and 6, FIG. 5 is a schematic diagram illustrating the illumination device 1 in FIG. 2 operated in a second state, and FIG. 6 is a sectional view illustrating the illumination device 1 along line X-X in FIG. 5. If the outer thread of the screw rod 162 is counterclockwise thread, the actuating unit 18 will actuate the screw rod 162 to rotate and then drive the sliding member 160 to slide with respect to the casing 10 in a direction D3 (as shown in FIG. 6) when the actuating unit 18 rotates in a clockwise direction CW (as shown in FIG. 5). At this time, the first and second protruding portions 124, 144 will move to upper positions with respect to the oblique sliding groove 1600 (as the second protruding portion 144 shown in FIG. 6), such that the first and second illumination units 12, 14 will rotate with respect to the driving mechanism 16 in a first direction R1 and a second direction R2 respectively (as shown in FIG. 5), wherein the first direction R1 is opposite to the second direction R2. In other words, when a user rotates the actuating unit 18 clockwise, the driving mechanism 16 is actuated to drive the first and second illumination units 12, 14 to rotate with respect to the driving mechanism 16 simultaneously, so as to convert the illumination device 1 from the first state (as shown in FIG. 2) to the second state (as shown in FIG. 5).

When the illumination device 1 is operated in the second state shown in FIG. 5, the first illumination direction D1 intersects the second illumination direction D2. At this time, the first illumination unit 12 generates a third illumination area A3 on the plane 3, the second illumination unit 14 generates a fourth illumination area A4 on the plane 3, and the third illumination area A3 overlaps the fourth illumination area A4 partially or wholly. Therefore, the light field generated by the illumination device 1 in the second state is more concentrative than the light field generated by the illumination device 1 in the first state. Accordingly, the user may easily change the light field generated by the illumination device 1 based on different illumination requirements.

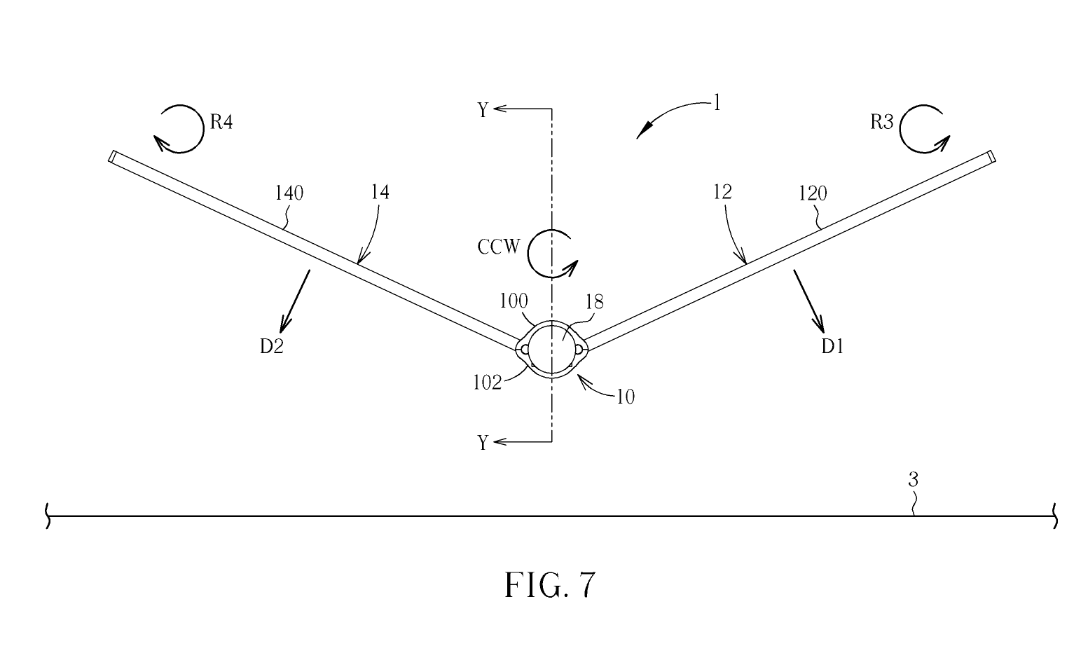

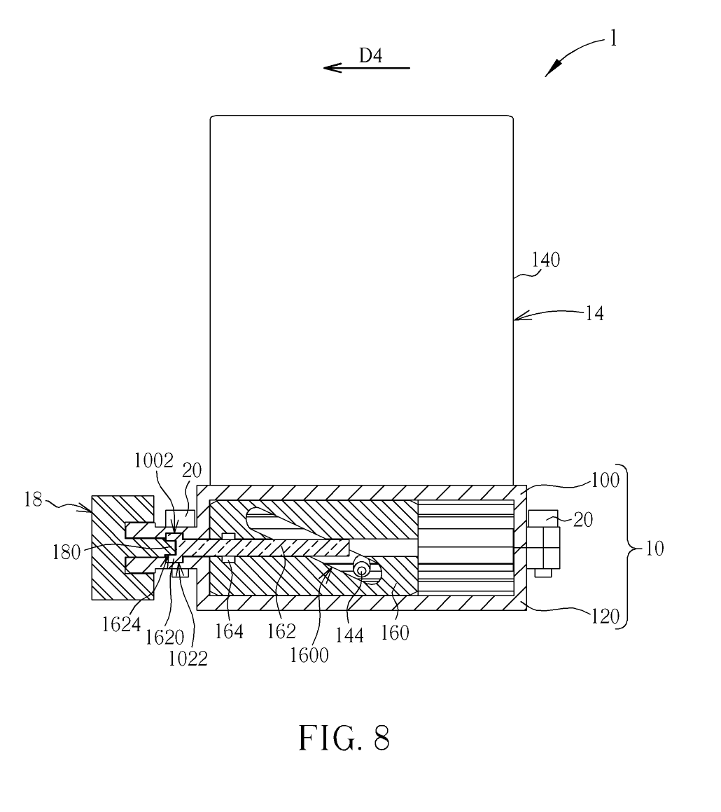

Referring to FIGS. 7 and 8, FIG. 7 is a schematic diagram illustrating the illumination device 1 in FIG. 2 operated in a third state, and FIG. 8 is a sectional view illustrating the illumination device 1 along line Y-Y in FIG. 7. When the actuating unit 18 rotates in a counterclockwise direction CCW (as shown in FIG. 7), the actuating unit 18 will actuate the screw rod 162 to rotate and then drive the sliding member 160 to slide with respect to the casing 10 in a direction D4 (as shown in FIG. 8). At this time, the first and second protruding portions 124, 144 will move to lower positions with respect to the oblique sliding groove 1600 (as the second protruding portion 144 shown in FIG. 8), such that the first and second illumination units 12, 14 will rotate with respect to the driving mechanism 16 in a third direction R3 and a fourth direction R4 respectively (as shown in FIG. 7), wherein the third direction R3 is opposite to the fourth direction R4. In other words, when the user rotates the actuating unit 18 counterclockwise, the driving mechanism 16 is actuated to drive the first and second illumination units 12, 14 to rotate with respect to the driving mechanism 16 simultaneously, so as to convert the illumination device 1 from the first state (as shown in FIG. 2) to the third state (as shown in FIG. 7). The light field generated by the illumination device 1 in the third state is more dispersive than the light field generated by the illumination device 1 in the first state.

It should be noted that if the outer thread of the screw rod 162 is clockwise thread, the sliding member 160 will move in the direction D4 shown in FIG. 8 when the actuating unit 18 rotates clockwise and will move in the direction D3 shown in FIG. 6 when the actuating unit 18 rotates counterclockwise.

As shown in FIG. 6, an angle α is included between the oblique sliding groove 1600 and a level. In this embodiment, the swing efficiency of the first and second illumination units 14 is dependent upon the angle α. For example, if the angle α increases, the sliding member 160 may slide with a shorter distance to enable the first and second illumination units 12, 14 to swing with a larger range. Preferably, the angle α may be, but not limited to, 45 degrees. Furthermore, the swing range of the first and second illumination units 12, 14 can be determined by a vertical height of the oblique sliding groove 1600.

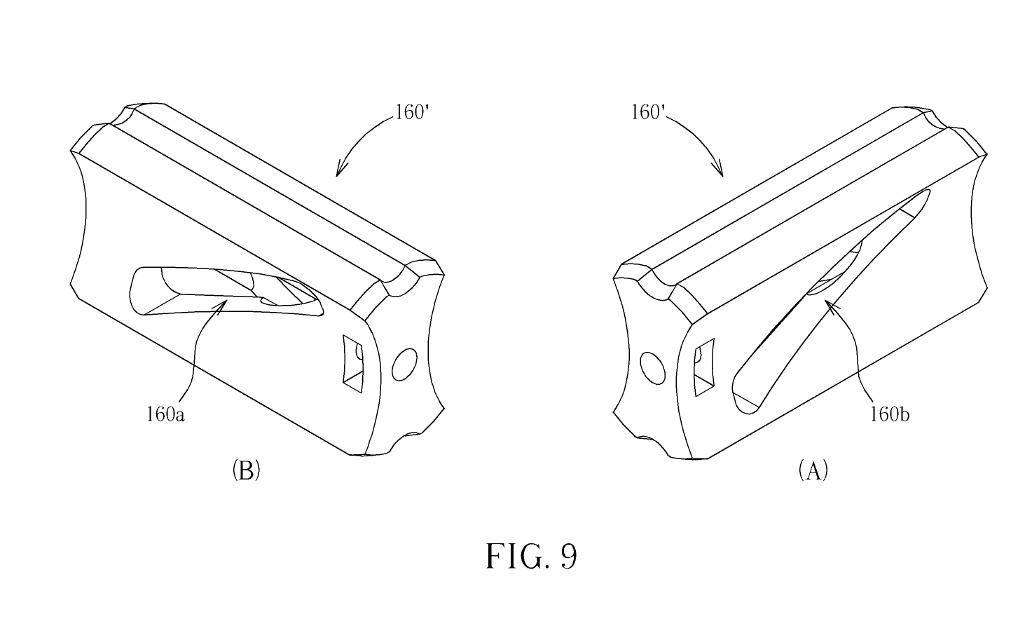

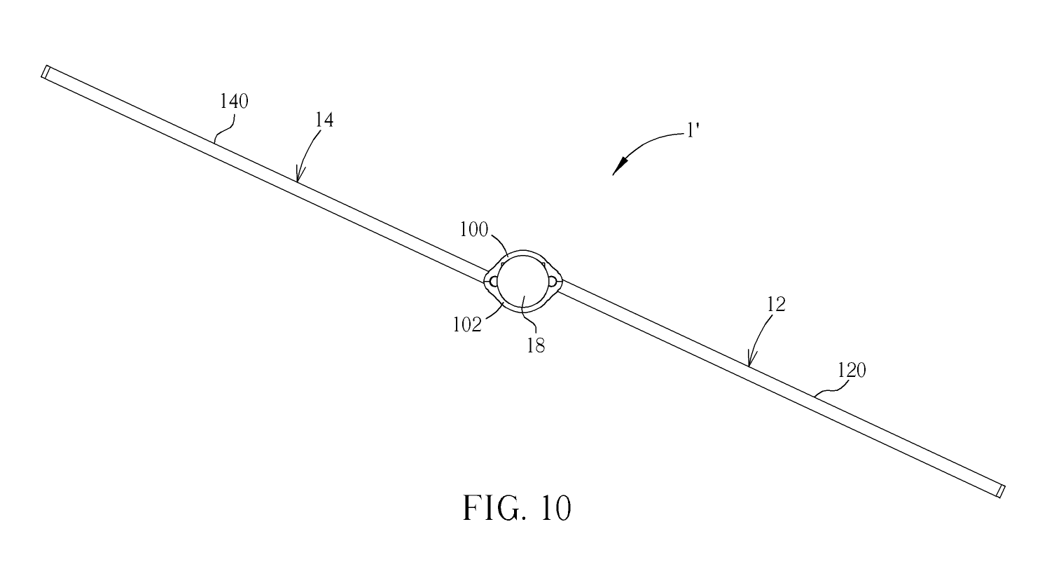

Referring to FIGS. 9 and 10, FIG. 9 is a perspective view illustrating a sliding member 160′ according to a second embodiment of the invention, wherein FIG. 9(A) is a right side perspective view and FIG. 9(B) is a left side perspective view; and FIG. 10 is a front view illustrating an illumination device 1′ according to the second embodiment of the invention. The main difference between the sliding member 160′ and the aforesaid sliding member 160 is that the sliding member 160′ has a first oblique sliding groove 160a and a second oblique sliding groove 160b. As shown in FIG. 9, the first and second oblique sliding groove 160a, 160b are formed on opposite sides of the sliding member 160′ respectively and the first oblique sliding groove 160a is opposite to the second oblique sliding groove 160b. The invention may replace the sliding member 160 shown in FIG. 3 with the sliding member 160′ shown in FIG. 9. At this time, the first protruding portion 124 of the first illumination unit 12 is disposed in the first oblique sliding groove 160a and the second protruding portion 144 of the second illumination unit 14 is disposed in the second oblique sliding groove 160b. When the sliding member 160′ slides with respect to the casing 10, the sliding member 160′ will drive the first and second illumination units 12, 14 to rotate in the same direction, as shown in FIG. 10.

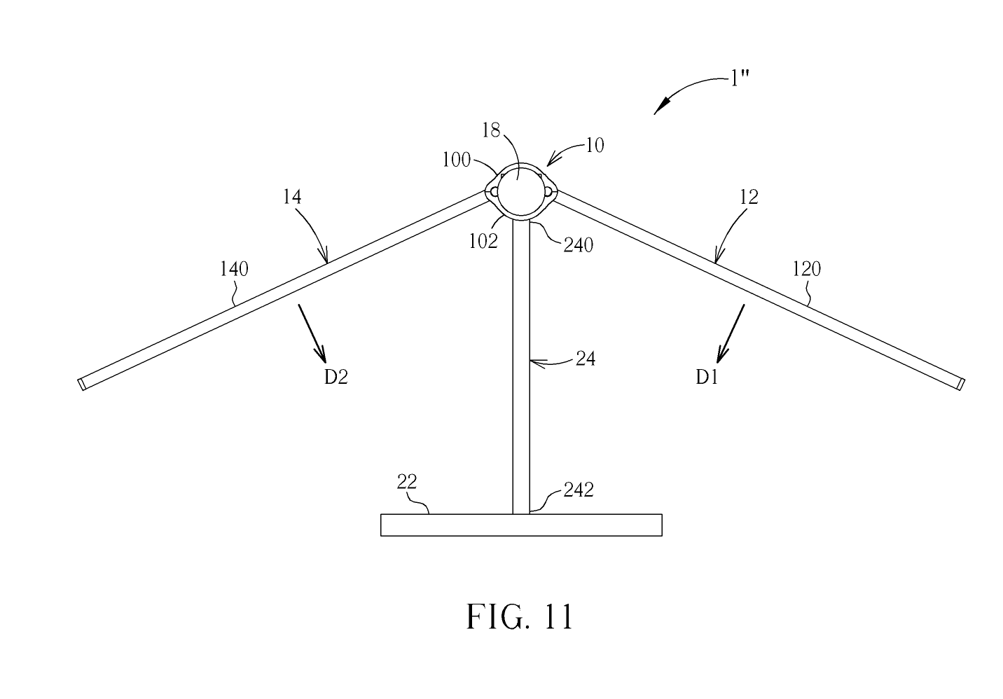

Referring to FIG. 11, FIG. 11 is a front view illustrating an illumination device 1″ according to a third embodiment of the invention. The main difference between the illumination device 1″ and the aforesaid illumination device 1 is that the illumination device 1″ further comprises a base 22 and a holder 24. A first end 240 of the holder 24 is connected to the lower casing 102 of the aforesaid casing 10 and a second end 242 of the holder 24 is fixed on the base 22. Accordingly, the illumination device 1″ can be used as a desk light. As shown in FIG. 11, when the illumination device 1″ is operated in the aforesaid second state, the first and second illumination directions D1, D2 point toward the base 22.

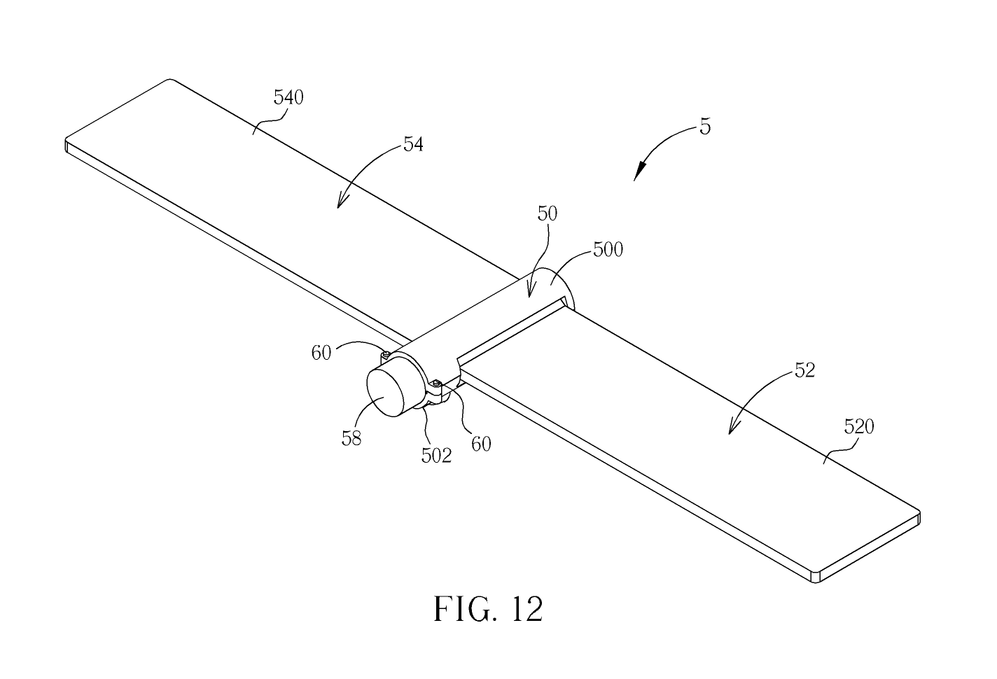

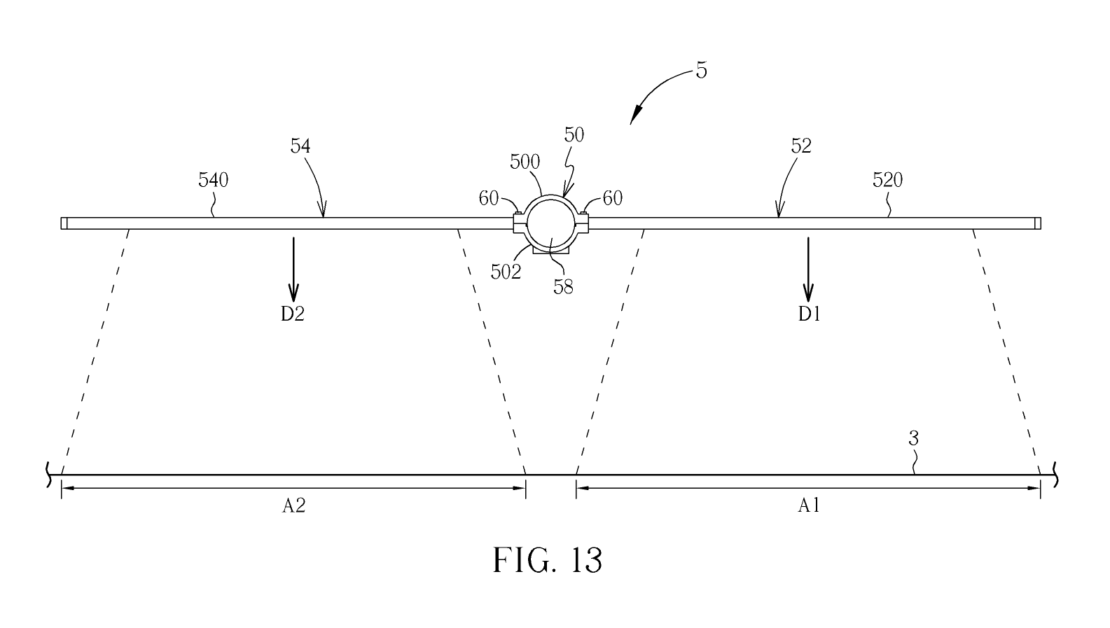

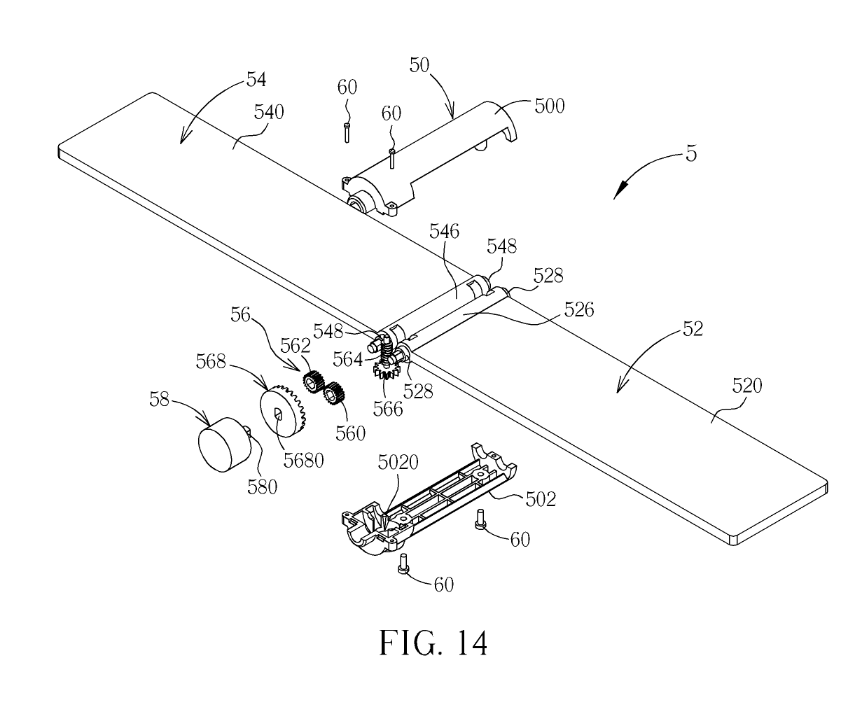

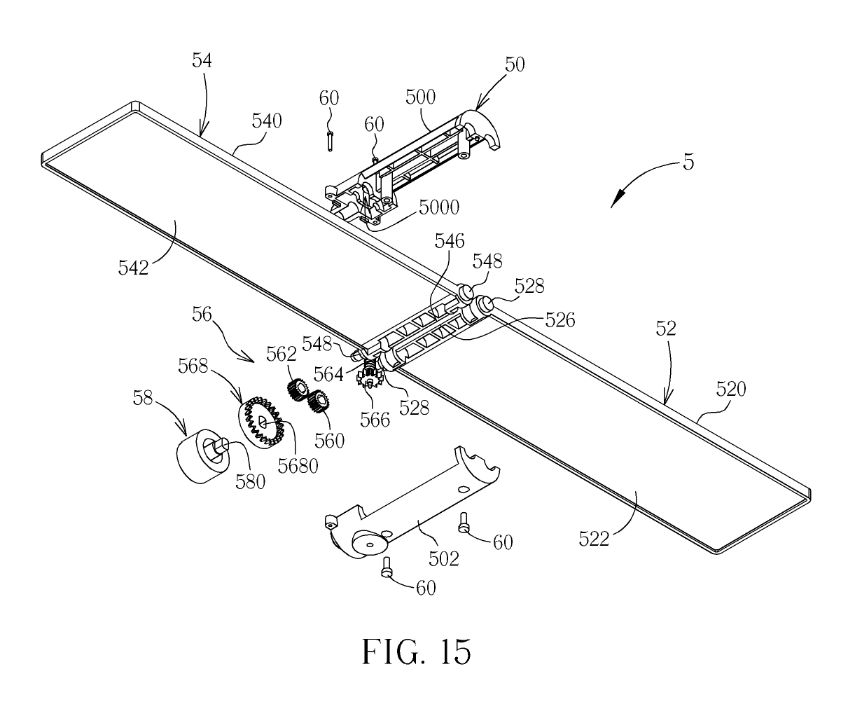

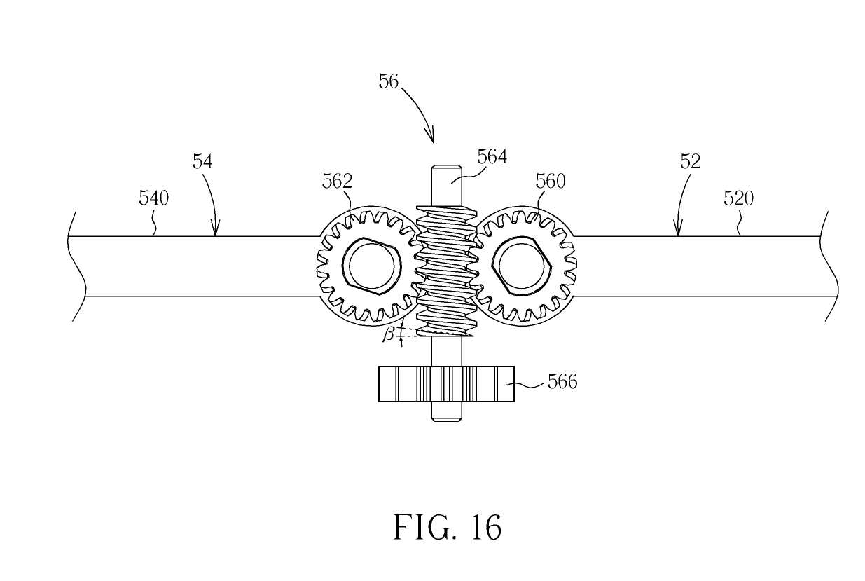

Referring to FIGS. 12 to 16, FIG. 12 is a perspective view illustrating an illumination device 5 according to a fourth embodiment of the invention, FIG. 13 is a front view illustrating the illumination device 5 shown in FIG. 12, FIG. 14 is an exploded view illustrating the illumination device 5 shown in FIG. 12, FIG. 15 is an exploded view illustrating the illumination device 5 shown in FIG. 12 from another view angle, and FIG. 16 is a front view illustrating the worm shaft 564 meshing with the first and second worm gears 560, 562 in FIG. 14. The illumination device 5 of the invention may be, but not limited to, fluorescent light, desk light, suspension light, street light, and so on. The illumination device 5 comprises a casing 50, a first illumination unit 52, a second illumination unit 54, a driving mechanism 56 and an actuating unit 58.

In this embodiment, the first illumination unit 52 may comprise a first rectangular flat structure 520 and a first light source module 522 and the first light source module 522 is disposed in the first rectangular flat structure 520. The second illumination unit 54 may comprise a second rectangular flat structure 540 and a second light source module 542 and the second light source module 542 is disposed in the second rectangular flat structure 540. It should be noted that the first and second light source modules 522, 542 can be also disposed in other structures including circular structure, oval-shaped structure, polygonal structure, and so on, so as to form the first and second illumination units 52, 54. That is to say, the invention is not limited to the aforesaid rectangular flat structure and can be designed based on practical applications. Furthermore, in practical applications, the first and second light source modules 522, 542 may be, but not limited to, light emitting diode modules.

The driving mechanism 56 is disposed in the casing 50. The casing 50 comprises an upper casing 500 and a lower casing 502. The upper and lower casings 500, 502 may be fixed together by a plurality of fixing members 60, such as screws. As shown in FIGS. 14 and 15, the upper casing 500 has an accommodating space 5000 and the lower casing 502 has an accommodating space 5020. In this embodiment, the driving mechanism 56 may comprise a first worm gear 560, a second worm gear 562, a worm shaft 564, a spur gear 566 and a crown gear 568.

The first illumination unit 52 can be pivotally connected to one side of the casing 50 by two pivoting portions 528 formed on opposite sides of a first connecting edge 526, and the second illumination unit 54 can be pivotally connected to the other side of the casing 50 by two pivoting portions 548 formed on opposite sides of a second connecting edge 546. The first worm gear 560 is disposed on one end of the first illumination unit 52 and the second worm gear 562 is disposed on one end of the second illumination unit 54, such that the first and second connecting edges 526, 546 are coupled to the driving mechanism 56 respectively. The worm shaft 564 is disposed between the first and second worm gears 560, 562 and meshing with the first and second worm gears 560, 562 respectively, as shown in FIG. 16.

The spur gear 566 is rotatably disposed in the accommodating space 5020 of the lower casing 502 and is connected to one end of the worm shaft 564, such that the worm shaft 564 can rotate together with the spur gear 566. The other end of the worm shaft 564 is disposed in the accommodating space 5000 of the upper casing 500. The crown gear 568 meshes with the spur gear 566. Furthermore, the actuating unit 58 is disposed on the casing 50 and an engaging portion 580 of the actuating unit 58 is connected to an engaging hole 5680 of the crown gear 568.

When the actuating unit 58 rotates, the actuating unit 58 actuates the crown gear 568 to rotate. Afterward, the crown gear 568 drives the spur gear 566 and the worm shaft 564 to rotate. Then, the worm shaft 564 drives the first and second worm gears 560, 562 to rotate so as to drive the first and second illumination units 52, 54 to rotate with respect to the driving mechanism 56.

As shown in FIG. 13, the illumination device 5 is disposed over a plane 7. The first illumination unit 52 has a first illumination direction D1 and the second illumination unit 54 has a second illumination direction D2. When the illumination device 5 is operated in the first state shown in FIG. 13, the first and second illumination directions D1, D2 are perpendicular to the plane 7, such that the first illumination direction D1 does not intersect the second illumination direction D2. At this time, the first illumination unit 52 generates a first illumination area A1 on the plane 7, the second illumination unit 54 generates a second illumination area A2 on the plane 7, and the first illumination area A1 is staggered with the second illumination area A2.

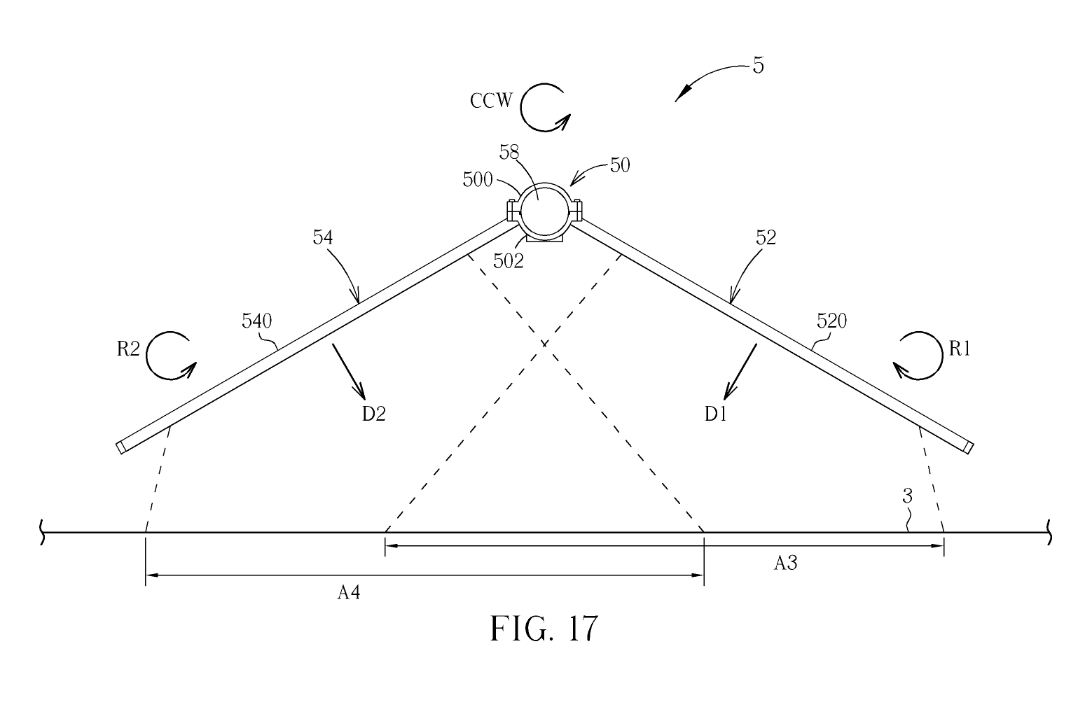

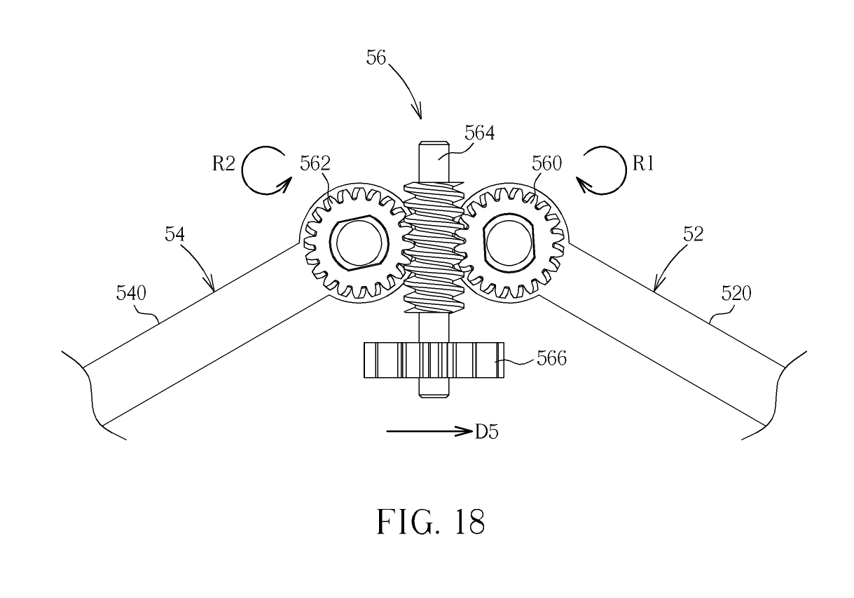

Referring to FIGS. 17 and 18, FIG. 17 is a schematic diagram illustrating the illumination device 5 in FIG. 13 operated in a second state, and FIG. 18 is a front view illustrating the worm shaft 564 meshing with the first and second worm gears 560, 562 when the illumination device 5 is operated in the second state. When the actuating unit 58 rotates in a counterclockwise direction CCW (as shown in FIG. 17), the actuating unit 58 will drive the crown gear 568 to rotate so as to drive the spur gear 566 and the worm shaft 564 to rotate with respect to the casing 50 in a direction D5 (as shown in FIG. 18). At this time, the first and second illumination units 52, 54 rotate together with the first and second worm gears 560, 562 respectively in a first direction R1 and a second direction R2, wherein the first direction R1 is opposite to the second direction R2. In other words, when a user rotates the actuating unit 58, the driving mechanism 56 is actuated to drive the first and second illumination units 52, 54 to rotate with respect to the driving mechanism 56 simultaneously, so as to convert the illumination device 5 from the first state (as shown in FIG. 13) to the second state (as shown in FIG. 17).

When the illumination device 5 is operated in the second state shown in FIG. 17, the first illumination direction D1 intersects the second illumination direction D2. At this time, the first illumination unit 52 generates a third illumination area A3 on the plane 7, the second illumination unit 54 generates a fourth illumination area A4 on the plane 7, and the third illumination area A3 overlaps the fourth illumination area A4 partially or wholly. Therefore, the light field generated by the illumination device 5 in the second state is more concentrative than the light field generated by the illumination device 5 in the first state. Accordingly, the user may easily change the light field generated by the illumination device 5 based on different illumination requirements.

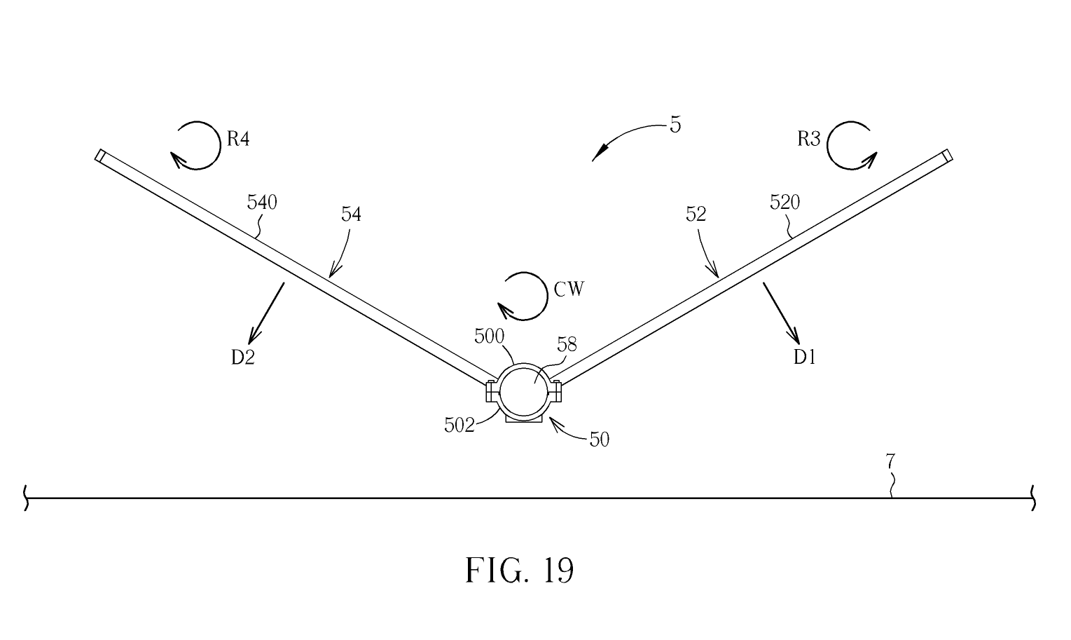

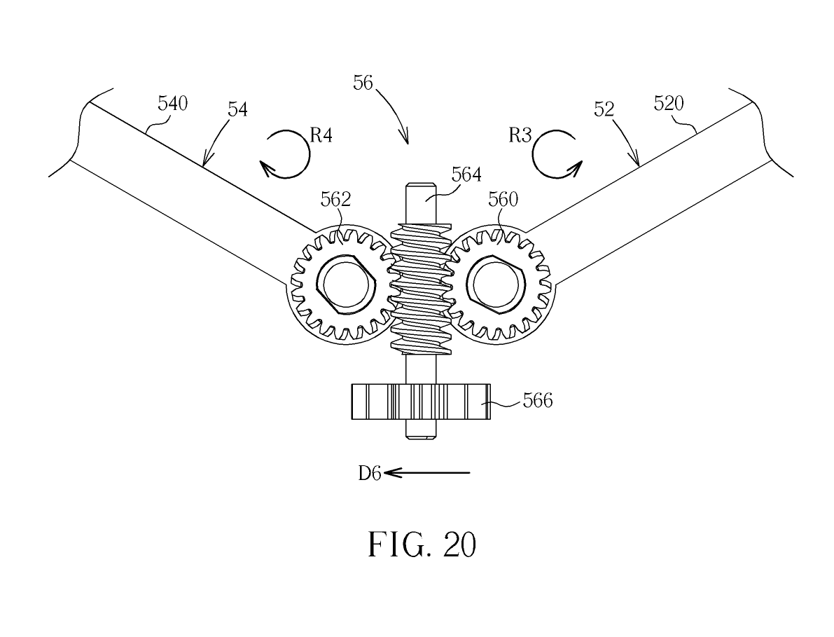

Referring to FIGS. 19 and 20, FIG. 19 is a schematic diagram illustrating the illumination device 5 in FIG. 13 operated in a third state, and FIG. 20 is a front view illustrating the worm shaft 564 meshing with the first and second worm gears 560, 562 when the illumination device 5 is operated in the third state. When the actuating unit 58 rotates in a clockwise direction CW (as shown in FIG. 19), the actuating unit 58 will drive the crown gear 568 to rotate so as to drive the spur gear 566 and the worm shaft 564 to rotate with respect to the casing 50 in a direction D6 (as shown in FIG. 20). At this time, the first and second illumination units 52, 54 rotate together with the first and second worm gears 560, 562 respectively in a third direction R3 and a fourth direction R4, wherein the first direction R3 is opposite to the second direction R4. In other words, when a user rotates the actuating unit 58, the driving mechanism 56 is actuated to drive the first and second illumination units 52, 54 to rotate with respect to the driving mechanism 56 simultaneously, so as to convert the illumination device 5 from the first state (as shown in FIG. 13) to the third state (as shown in FIG. 19). The light field generated by the illumination device 5 in the third state is more dispersive than the light field generated by the illumination device 5 in the first state.

As shown in FIG. 16, the worm shaft 548 has a helix angle β. In this embodiment, if the helix angle β increases, the first and second illumination units 52, 54 rotate with a larger range when the worm shaft 548 rotates. Preferably, the helix angle β may be, but not limited to, 10 degrees.

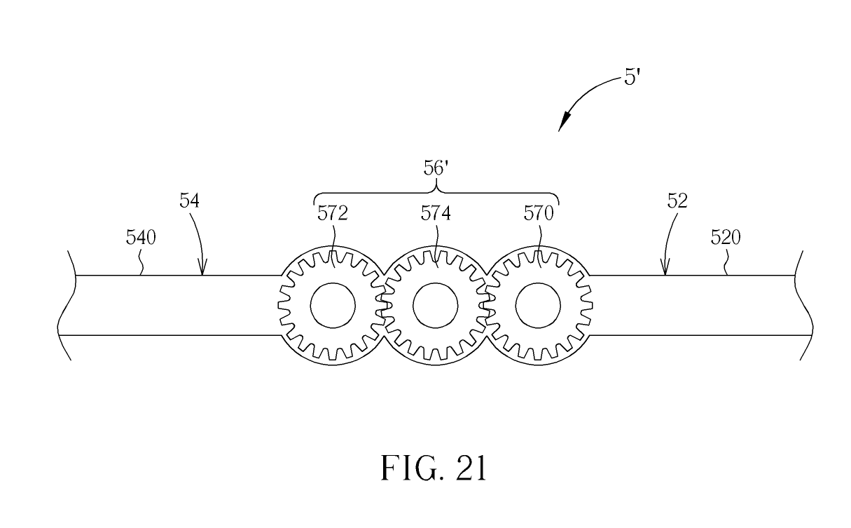

Referring to FIG. 21, FIG. 21 is an inner front view illustrating an illumination device 5′ according to a fifth embodiment of the invention. The main difference between the illumination device 5′ and the aforesaid illumination device 5 is that the driving mechanism 56′ of the illumination device 5′ has a first spur gear 570, a second spur gear 572 and a third spur gear 574. As shown in FIG. 21, the first spur gear 570 is disposed on one end of the first illumination unit 52, the second spur gear 572 is disposed on one end of the second illumination unit 54, and the third spur gear 574 is disposed between the first and second spur gears 570, 572 and meshes with the first and second spur gears 570, 572 respectively. When the third spur gear 574 rotates, the first and second illumination units 52, 54 will be driven to rotate in the same direction.

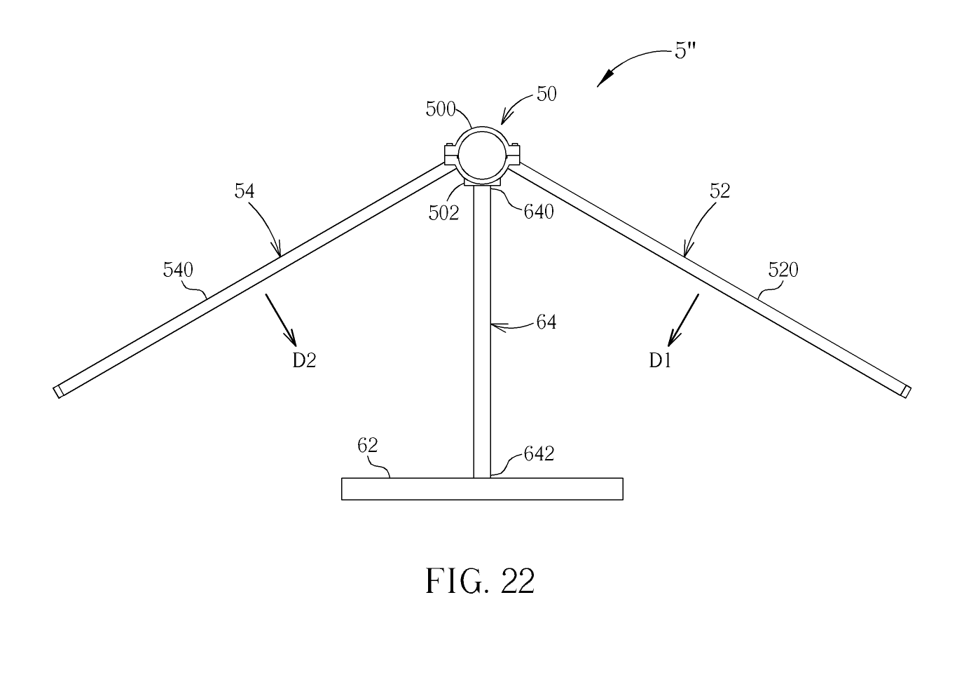

Referring to FIG. 22, FIG. 22 is a front view illustrating an illumination device 5″ according to a sixth embodiment of the invention. The main difference between the illumination device 5″ and the aforesaid illumination device 5 is that the illumination device 5″ further comprises a base 62 and a holder 64. A first end 640 of the holder 64 is connected to the lower casing 502 of the aforesaid casing 50 and a second end 642 of the holder 64 is fixed on the base 62. Accordingly, the illumination device 5″ can be used as a desk light. As shown in FIG. 22, when the illumination device 5″ is operated in the aforesaid second state, the first and second illumination directions D1, D2 point toward the base 62.

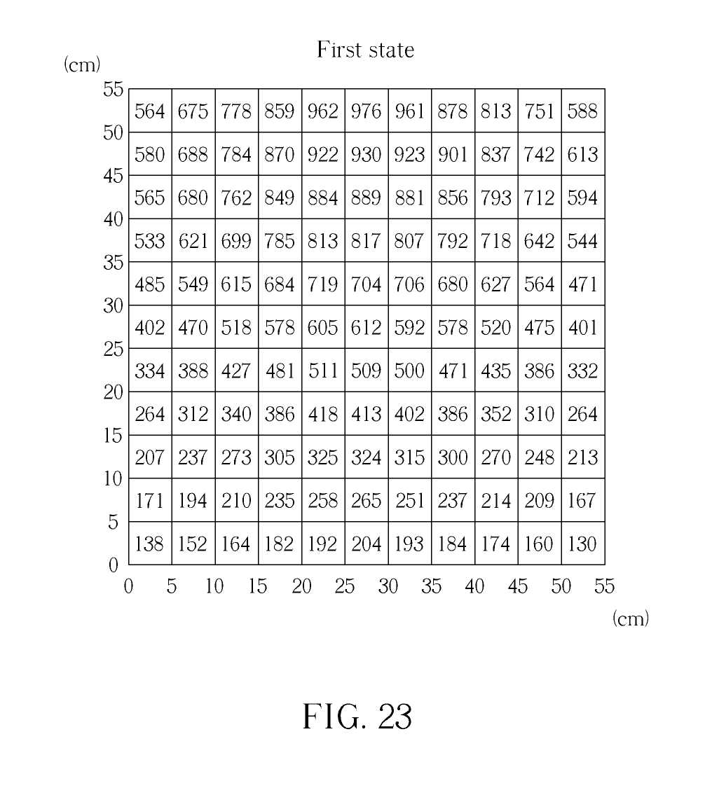

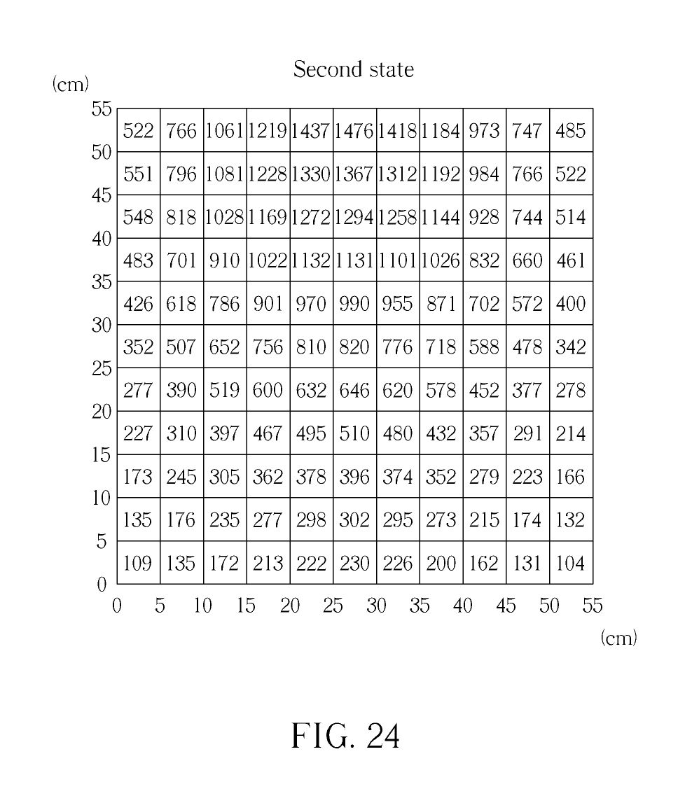

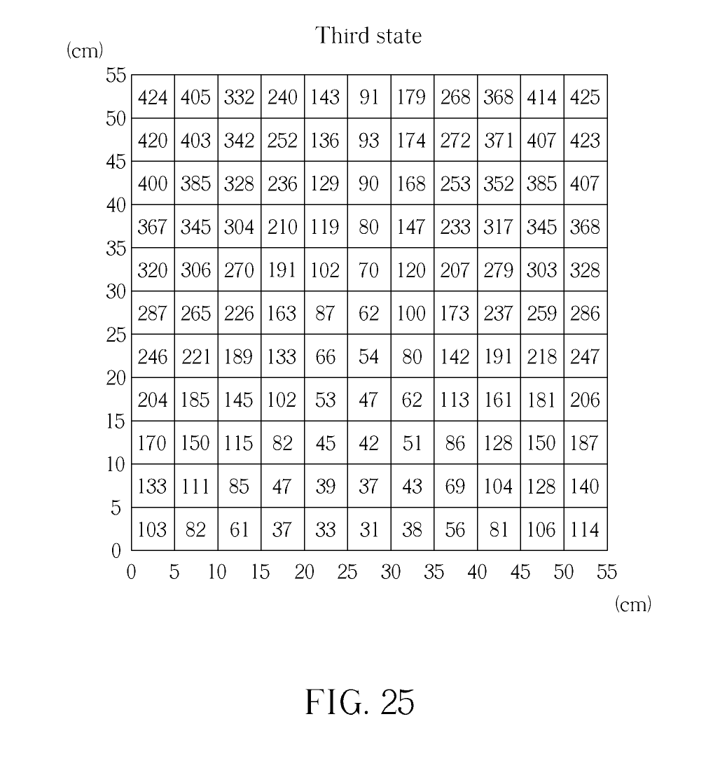

Referring to FIGS. 23 to 25, FIG. 23 is a diagram illustrating the illumination distribution of the illumination 1 or 5 operated in the first state, FIG. 24 is a diagram illustrating the illumination distribution of the illumination 1 or 5 operated in the second state, and FIG. 25 is a diagram illustrating the illumination distribution of the illumination 1 or 5 operated in the third state. As shown in FIGS. 23 to 25, the aforesaid plane 3 or 7 may consist of 11*11 grids, each grid is defined as 5*5 cm, and the illumination 1 or 5 is placed at the upper edge of the square. The number in each grid represents an illumination value. As the illumination values shown in FIGS. 23 and 24, the light field generated by the illumination device 1 or 5 in the second state is more concentrative than the light field generated by the illumination device 1 or 5 in the first state. As the illumination values shown in FIGS. 23 and 25, the light field generated by the illumination device 1 or 5 in the third state is more dispersive than the light field generated by the illumination device 1 or 5 in the first state.

Compared to the prior art, the driving mechanism of the illumination device of the invention is capable of driving the first and second illumination units to rotate simultaneously in the opposite or the same direction, such that the first illumination direction intersects or does not intersect the second illumination direction. Accordingly, a user may easily change light field generated by the illumination device based on different illumination requirements.

Those skilled in the art will readily observe that numerous modifications and alterations of the device and method may be made while retaining the teachings of the invention.

What is claimed is:

1. An illumination device comprising:
a first illumination unit having a first illumination direction;
a second illumination unit having a second illumination direction; and
a driving mechanism, the first and second illumination units being pivotally connected to the driving mechanism, the driving mechanism being capable of driving the first and second illumination units to rotate with respect to the driving mechanism;
wherein the illumination device is capable of being operated in a first state and a second state; when the illumination device is operated in the first state, the first illumination direction does not intersect the second illumination direction; and when the illumination device is operated in the second state, the first illumination direction intersects the second illumination direction.

2. The illumination device of claim 1, wherein the illumination device is disposed over a plane; when the illumination device is operated in the first state, the first illumination unit generates a first illumination area on the plane, the second illumination unit generates a second illumination area on the plane, and the first illumination area is staggered with the second illumination area; and when the illumination device is operated in the second state, the first illumination unit generates a third illumination area on the plane, the second illumination unit generates a fourth illumination area on the plane, and the third illumination area overlaps the fourth illumination area partially or wholly.

3. The illumination device of claim 1, wherein the illumination device further comprises a casing, the driving mechanism is disposed in the casing, the driving mechanism drives the first and second illumination units to rotate along a first direction and a second direction respectively, and the first direction is opposite to the second direction.

4. The illumination device of claim 1, wherein the driving mechanism drives the first and second illumination units to rotate with respect to the driving mechanism simultaneously, so as to convert the illumination device from the first state to the second state.

5. The illumination device of claim 1, wherein the first illumination unit has a first connecting edge, the second illumination unit has a second connecting edge, the first and second connecting edges are coupled to the driving mechanism respectively, the illumination device further comprises:
a base; and
a holder, a first end of the holder being connected to the illumination device, and a second end of the holder being fixed on the base.

6. The illumination device of claim 5, wherein when the illumination device is operated in the second state, the first and second illumination directions point toward the base.

7. The illumination device of claim 1, wherein the illumination device further comprises a casing, the driving mechanism comprises a sliding member slidably disposed in the casing, the sliding member has an oblique sliding groove, the first and second illumination units are pivotally connected to opposite sides of the casing respectively, one end of the first illumination unit, which is pivotally connected to the casing, has a first protruding portion, one end of the second illumination unit, which is pivotally connected to the casing, has a second protruding portion, the first and second protruding portions are disposed in the oblique sliding groove from opposite sides of the oblique sliding groove respectively.

8. The illumination device of claim 7, wherein the first illumination unit comprises a first rectangular flat structure and a first light source module, the first protruding portion protrudes from one end of the first rectangular flat structure, and the first light source module is disposed in the first rectangular flat structure; the second illumination unit comprises a second rectangular flat structure and a second light source module, the second protruding portion protrudes from one end of the second rectangular flat structure, and the second light source module is disposed in the second rectangular flat structure.

9. The illumination device of claim 7, wherein one end of the sliding member has an opening, there is a screw structure formed in the opening, the driving mechanism further comprises a screw rod, one end of the screw rod is rotatably and immovably disposed in the casing, and another end of the screw rod is disposed in the opening so as to mesh with the screw structure.

10. The illumination device of claim 9, wherein the driving mechanism further comprises a screw nut disposed in the opening and used to provide the screw structure.

11. The illumination device of claim 9, further comprising an actuating unit disposed on the casing and connected to the screw rod, wherein the actuating unit is used to actuate the screw rod to rotate.

12. The illumination device of claim 7, wherein an angle included between the oblique sliding groove and a level is 45 degrees.

13. The illumination device of claim 1, wherein the illumination device further comprises a casing, the first and second illumination units are pivotally connected to opposite sides of the casing, the driving mechanism comprises:
a first worm gear disposed on one end of the first illumination unit;
a second worm gear disposed on one end of the second illumination unit; and
a worm shaft disposed between the first and second worm gears and meshing with the first and second worm gears respectively.

14. The illumination device of claim 13, wherein the first illumination unit comprises a first rectangular flat structure and a first light source module, and the first light source module is disposed in the first rectangular flat structure; the second illumination unit comprises a second rectangular flat structure and a second light source module, and the second light source module is disposed in the second rectangular flat structure.

15. The illumination device of claim 13, wherein the driving mechanism further comprises a spur gear and a crown gear, the spur gear is connected to one end of the worm shaft, and the crown gear meshes with the spur gear.

16. The illumination device of claim 15, further comprising an actuating unit disposed on the casing and connected to the crown gear, wherein the actuating unit is used to actuate the crown gear to rotate.

17. The illumination device of claim 13, wherein a helix angle of the worm shaft is larger than 10 degrees.
